(19) United States
(12) Patent Application Publication
(10) Pub. No.: US 2003/0030816 A1
(43) Pub. Date: Feb. 13, 2003

(54) Nonlinearity error correcting method and phase angle measuring method for displacement measurement in two-freqency laser interferometer and displacement measurement system using the same

(76) Inventors: Tae Bong Eom, Taejon (KR); Ho Suhng Suh, Taejon (KR); Tae Young Choi, Taejon (KR)

Correspondence Address: Irving M. Weiner, WEINER & BURT, P.C., 635 N. US-23, P.O BOX 186, HARRISVILLE, MI, 48740, US

(21) Appl. No.: 10/051,375

(22) Filed: Jan. 17, 2002

(30) Foreign Application Priority Data
Aug. 11, 2001 (KR) 2001-48463
Aug. 28, 2001 (KR) 2001-52030

(51) Int. Cl. G01B 9/02

(52) U.S. Cl. 356/486

(57) ABSTRACT

Disclosed is a method for correcting a nonlinearity error in a two-frequency laser interferometer which measures the phase angle using 90° phase mixing technique and a method for measuring a phase angle by using the same. The phase angle correcting method includes the steps of: calculating ellipse parameters, such as amplitudes, offsets and a phase difference of two sine and cosine output signals from the nonlinearity error correcting electronics; calculating an adjusting voltages for correcting offsets, amplitudes and a phase of the output signals; conducting a correction wherein offsets of output signals become zero, amplitudes are same, and a phase difference beyond 90° between the output signals becomes zero; and applying the output signals whose offsets, amplitudes and phase are corrected to Equation (θ=arctan(I_{y}′/Iₓ′)) to calculate the phase angle. Therefore, the present invention has an advantage of drastically improving accuracy in the displacement measurement using the two-frequency laser interferometer by correcting the offsets, the amplitudes, the phases, or the likes with respect to the output signals of the 90° phase mixer and thus eliminating the periodic nonlinearity error generated in the two-frequency laser interferometer.

### BACKGROUND OF THE INVENTION

1. Field of the Invention

The present invention relates to a phase angle measuring method and a nonlinearity error correcting method in a two-frequency laser interferometer used for displacement measurement and a system using the same, and more particularly, to a phase angle measuring method and a nonlinearity error correcting method in a two-frequency laser interferometer for displacement measurement and system using the same, which can drastically improve accuracy in displacement measurement by adjusting offsets, amplitudes and phase between two output signals from phase demodulator used for phase angle measurement in a two-frequency laser interferometer.

2. Background of the Related Art

FIG. 1 illustrates a typical configuration of an optical system and a phase measuring electronics in a two-frequency laser interferometer for displacement measurement.

A laser 1 emits two orthogonally linear-polarized beams with different frequencies ω₁ and ω₂ (wavelength λ₁ and λ₂), and amplitudes A and B. A beamsplitter 2 splits the laser into two beams, one for reference and the other for measurement.

A reflected beam at the beamsplitter 2 passes through a polarizer 5a, which is oriented at 45° to a laser polarization axis, and falls on a photodetector 6a.

Here, electromagnetic fields Er₁ and Er₂ of two orthogonally linear-polarized laser beams are expressed as the following Equations 1 and 2:

[Equation 1]

Er₁=Aexp[i(ω₁t+θ_{A})]

[Equation 2]

Er₂=Bexp[i(ω₂t+θ_{B})]

where θ_{A} and θ_{B} represent initial phases. The output signal Iᵣ of the photodetector 6a is detected as an interference signal of the two laser beams and expressed by the following Equation 3:

[Equation 3]

Iᵣ∝(A²+B²)/2+AB cos[Δωt+(θ_{B}−θ_{A})]

where, Δω represents a frequency difference (ω₁-ω₂) of the two laser beams, and the output signal of Equation 3 serves as a reference signal.

The transmitted beam at the beamsplitter 2 is completely separated at a polarizing beamsplitter 3 so that each beam has its own frequency and polarization direction, provided that a frequency mixing is absent. These two beams are reflected by a fixed mirror 4a and a moving mirror 4b usually employing a corner cube prism, and recombined on the polarizing beamsplitter again.

Here, the laser beams cover paths of different length L₁ and L₂. The L₁ signifies a distance from the polarizing beamsplitter 3 to the fixed mirror 4a and the L₂ signifies a distance from the polarizing beamsplitter 3 to the moving mirror 4b. The laser beams pass through a polarizer 5b and then an interference signal of the two laser beams is detected in a photodetector 6b.

Here, electromagnetic fields Em₁ and Em₂ of the two orthogonally linear-polarized beams are given by the following Equations 4 and 5:

[Equation 4]

Em₁=Aexp[i(ω₁t+θ_{A})]

[Equation 5]

Em₂=Bexp[i(ω₂t+θ_{B}+θ)]

The output Iₘ of the photodetector 6b is detected as an interference signal of the two laser beams expressed as Equations 4 and 5. The output signal, which serves as a measurement signal, is expressed as the following Equation 6:

[Equation 6]

Iₘ∝(A²+B²)/2+AB cos[Δωt+(θ_{B}−θ₄)+θ]

where θ is a phase angle, generated by a change in optical path lengths (L) of the two mirrors 4a and 4b which are reflectors, and is expressed by the following Equation 7:

[Equation 7]

θ=4πnL/λ

where n indicates a refractive index of a medium, generally air through which the laser beam passes and L is a relative displacement (L₁-L₂) between the moving mirror 4b relative to the fixed mirror 4a. The above Equations 3 and 6 show sinusoidal signals having different phases and beat frequencies which are a frequency difference Δω of the two beams.

Therefore, a displacement L of the mirrors is determined by measuring the phase difference θ between the two interference signals, Iᵣ of Equation 3 and Iₘ of Equation 6. There are several ways to measure the phase difference θ. Here, a 90° phase mixing technique related to the present invention will be explained.

Initially, a 90° phase mixing electronics includes a 90° phase shifter 7 and two mixers 8a and 8b. The 90° phase mixing part receives two beat signals Iᵣ and Iₘ and outputs signals proportional to sine and cosine of the phase angle θ. Here, the signals of sine and cosine having 90° phase difference are used to measure magnitude and direction of the displacement of the moving mirror.

Function of the 90° phase mixing electronics will be explained in detail as follows. Two beat signals Iᵣ and Iₘ, signals corresponding to the beat frequency of Δω are passed by high-pass filters. The reference beat signal Iᵣ from the photodetector 6a is divided into an existing reference beat signal and a reference beat signal having a 90° phase difference by the 90° phase shifter 7. The measurement beat signal Iₘ from the photodetector 6b is divided into two signals having same phases. The four reference and measuring beat signals are multiplied by the two mixers 8a and 8b and output into such two signals as the following Equations 8 and 9:

[Equation 8]

I_{X}∝cos(Δωt)cos(Δωt+θ)

[Equation 9]

I_{Y}∝sin(Δωt)cos(Δωt+θ)

High frequency terms of these signals Iₓ and I_{Y} are removed while passing through low-pass filters 9a and 9b. Only signals I_{y} and I_{Y} including the phase angle θ are output from low-pass filters 9a and 9b and obtained by the following Equations 10 and 11:

[Equation 10]

I_{X}∝cos θ

[Equation 11]

I_{Y}∝sin θ

Referring to the signals Iₓ and I_{Y} of Equations 10 and 11, there is a 90° phase difference between the two signals as shown in FIG. 2. Perfect sine and cosine signals with no offsets and same amplitudes are obtained. Further, A Lissajou figure drawn by corresponding the above signals Iₓ and I_{Y} to X and Y axes of an orthogonal coordinate creates a perfect circle as shown in FIG. 3. In case of such nonlinear-free signals expressed by Equations 10 and 11, the phase angle θ can be easily calculated from the following Equation 12:

[Equation 12]

θ=arctan(I_{Y}/I_{X})

However, this equation is applicable under ideal condition that two beams with slightly different frequencies, ω₁ and ω₂, are completely separated at the polarizing beamsplitter 3.

However, this condition cannot be met in a real application. In practice, the two beams are not completely separated at the polarizing beamsplitter 3 and each arm contains a small component of the frequency intended for the other arm by various kinds of factors such as non-orthogonality of the polarization directions of the input beams, elliptical polarization of the beams, misalignment of the polarization beamsplitter and imperfection of the polarizing beamsplitter 3.

These errors result in nonlinear relationship between the phase angle θ measured and the relative displacement between the two mirrors. It means that the calculated displacement using Equation 12 will have the nonlinearity error which has a periodic characteristics.

Accordingly, the conventional method using only the 90° phase mixing technique in the two-frequency laser interferometer does not consider the nonlinearity error caused by the frequency mixing, thereby resulting in error in displacement measurement.

### SUMMARY OF THE INVENTION

Accordingly, the present invention is directed to a nonlinearity error correcting method and a phase angle measuring method and system using the same that substantially obviates one or more problems due to limitations and disadvantages of the related art.

An object of the present invention is to provide a nonlinearity error correcting method and a phase angle measuring method and system using the same which can drastically improve accuracy of displacement measurement in a two-frequency laser interferometer by measuring and correcting offsets, amplitudes and phases of two sine and cosine output signals from a 90° phase mixing electronics used for measuring a phase angle in the two-frequency laser interferometer.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a phase angle measuring method for displacement measurement in a two-frequency laser interferometer, which uses a two-frequency laser, a 90° phase mixing electronics and a phase angle calculating electronics and performs the steps of mixing a reference signal Iᵣ produced due to an interference of the two frequency laser beams and a 90 phase shifted reference signal with a measurement signal Iₘ produced due to an interference of two frequency-laser beams reflected on the fixed and moving mirrors, filtering high frequency terms to produce two output signals Iₓ and I_{y}, and obtaining a phase angle θ for displacement measurement, the phase angle measuring method comprising the steps of obtaining the output signals output from the 90° phase mixing electronics, and ellipse parameters including amplitudes a and b, offsets Iₓₒ and I_{y0} and difference from phase-quadrature φ included in two output signals and applying the same to the following Equation to calculate the phase angle θ:

θ=tan⁻¹[cos φ/[sin φ+(b/a)/(Iₓ−Iₓ₀)(I_{y}−I_{y0})]]

In another aspect of the present invention, a phase angle measuring method for displacement measurement in a two-frequency laser interferometer, which uses a two-frequency laser, a 90° phase mixing electronics and a phase angle calculating electronics and performs the steps of mixing a reference signal Iᵣ produced due to an interference of two-frequency laser beams and a 90° phase shifted reference signal with a measurement signal Iₘ produced due to an interference of two-frequency laser beams reflected on fixed and moving mirrors, filtering high frequency terms to produce two output signals Iₓ and I_{y}, and obtaining a phase angle θ for displacement measurement, the phase angle measuring method comprising the steps of: obtaining ellipse parameters including amplitudes a and b, offsets Iₓₒ and I_{yo} and difference from phase-quadrature φ included in two output signals Iₓ and I_{y} which are output from the 90° phase mixing electronics; applying the ellipse parameters and the output signals Iₓ and I_{y} to the following Equation to calculate the phase angle θ; making out a lookup table with data which form the output signals Iₓ and I_{y} and the phase angle θ calculated from the output signals as a set; and reading the phase angle θ forming the set with the output signals Iₓ and I_{y} from the 90° phase mixing electronics when the phase angle θ is measured:

θ=tan⁻¹[cos φ/[sin φ+(b/a)/(Iₓ−Iₓ₀)/(I_{y}−I_{y0})]]

In still another aspect of the present invention, a nonlinearity error correcting method for displacement measurement in a two-frequency laser interferometer, which uses a two-frequency, a 90° phase mixing electronics, a nonlinearity error correcting electronics and a phase calculating electronics and performs the steps of mixing a reference signal Iᵣ produced due to an interference of two-frequency laser beams and a 90° phase shifted reference signal with a measurement signal Iₘ produced due to an interference of two-frequency laser beams reflected on fixed and moving mirrors, filtering high frequency terms to produce output signals Iₓ and I_{y}, and obtaining a phase angle θ for the displacement measurement, the nonlinearity error correcting method comprising the steps of: calculating ellipse parameters including amplitudes a and b, offsets Iₓₒ and I_{yo} and difference from phase-quadrature φ of two output signals Iₓ and I_{y}; calculating an adjusting voltage for correcting amplitudes a and b, offsets Iₓₒ and I_{yo}, and difference from phase-quadrature φ of two output signals Iₓ and I_{y}; and conducting a correction wherein the offsets Iₓₒ and I_{yo} of output signals Iₓ′ and I_{y}′ from the nonlinearity error correcting electronics become zero, the amplitudes a and b have a same value, and difference from phase-quadrature θ between the output signals Iₓ′ and I_{y}′ becomes zero.

In yet another aspect of the present invention, a phase angle measuring method for displacement measurement in a two-frequency laser interferometer, which uses a two-frequency laser, a 90° phase mixing electronics, a nonlinearity error correcting electronics and a phase calculating electronics and performs the steps of mixing a reference signal Iᵣ produced due to an interference of two-frequency laser beams and a 90° phase shifted reference signal with a measurement signal Iₘ produced due to an interference of two-frequency laser beams reflected on fixed and moving mirrors, filtering high frequency terms to produce output signals Iₓ and I_{y}, and obtaining a phase angle θ for displacement measurement, the phase angle measuring method comprising the steps of: calculating ellipse parameters including amplitudes a and b, offsets Iₓₒ and I_{yo} and difference from phase-quadrature φ of two output signals Iₓ′ and I_{y}′ from the nonlinearity error correcting electronics; calculating an adjusting voltage for correcting offsets, amplitudes and phases of the output signals Iₓ′ and I_{y}′; conducting a correction wherein the offsets Iₓₒ and I_{yo} of the output signals Iₓ′ and I_{y}′ from the nonlinearity error correcting electronics become zero, the amplitudes a and b have a same value, and difference from phase-quadrature φ between the output signals Iₓ′ and I_{y}′ becomes zero; and applying the output signals Iₓ′ and I_{y}′ whose offsets, Ak amplitudes and phase are corrected to the following Equation to calculate the phase angle θ:

θ=arctan(I_{y}/Iₓ)

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a typical construction of a conventional phase angle measuring system for displacement measurement in a two-frequency laser interferometer;

FIG. 2 illustrates an typical view of two output signals Iₓ and I_{y}, perfect sine and cosine signals, from a 90′ phase mixing electronics when a nonlinearity error is absent in an optical system and an electronics, wherein there are no offsets, amplitudes are same, and a phase difference of the two output signals Iₓ and I_{y} is 90′;

FIG. 3 illustrates a Lissajou figure of the two output signals Iₓ and I_{y} of FIG. 2, wherein the figure is a perfect circle when any nonlinearity error is absent;

FIG. 4 illustrates a view of a phase angle measuring system for displacement measurement in a two-frequency laser interferometer according to the present invention;

FIG. 5 illustrates a view of a nonlinearity error correcting method in a two-frequency interferometer and a phase angle measuring method and system for displacement measurement using the same according to the present invention;

FIG. 6 illustrates an exemplary view of two output signals Iₓ and I_{y} of a 90′ phase mixing electronics when a nonlinearity error is present in an optical system and an electronic system, wherein there exist offsets, amplitudes are different, and a phase difference between the two output signals Iₓ and I_{y} is not 90°;

FIG. 7 illustrates a Lissajou figure of the two output signals Iₓ and I_{y} of FIG. 5 which are the same as the signals of FIG. 6, wherein the figure is an ellipse circle distorted due to a nonlinearity error;

FIG. 8 illustrates a view for showing that the nonlinearity error is decreased when the correcting method of the present invention is applied, wherein a dotted line represents a nonlinearity error before correction and a solid line represents a nonlinearity error remained after the correction; and

FIG. 9 illustrates a comparative view for showing a difference in displacement measurement between a capacitance-type displacement sensor and a laser interferometer, wherein the error correcting method of the present invention is superior in removing a periodic nonlinearity error to the conventional art.

### DETAILED DESCRIPTION OF THE PREFERRED EMBODIMENTS

Reference will now be made in detail to the preferred embodiments of the present invention, examples of which are illustrated in the accompanying drawings.

While several embodiments of the present invention are explained hereinafter, detail description of an interferometer 100 and a 90′ phase mixing electronics 200 is left out since they are the same as those of the conventional art in construction. Like numerals are given to like components.

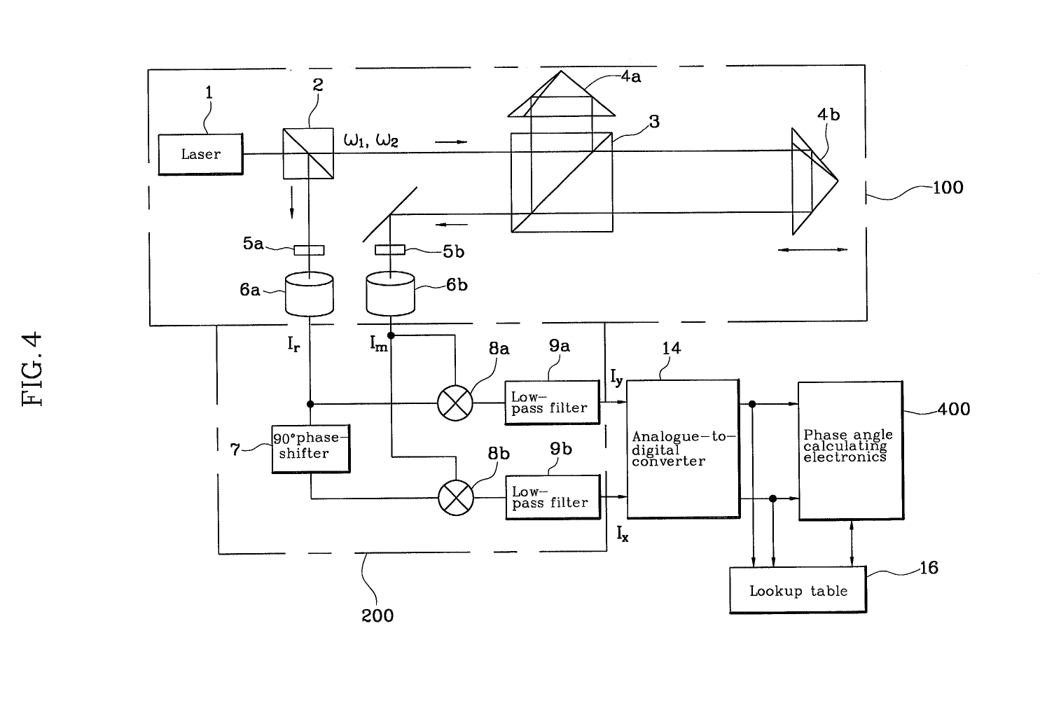

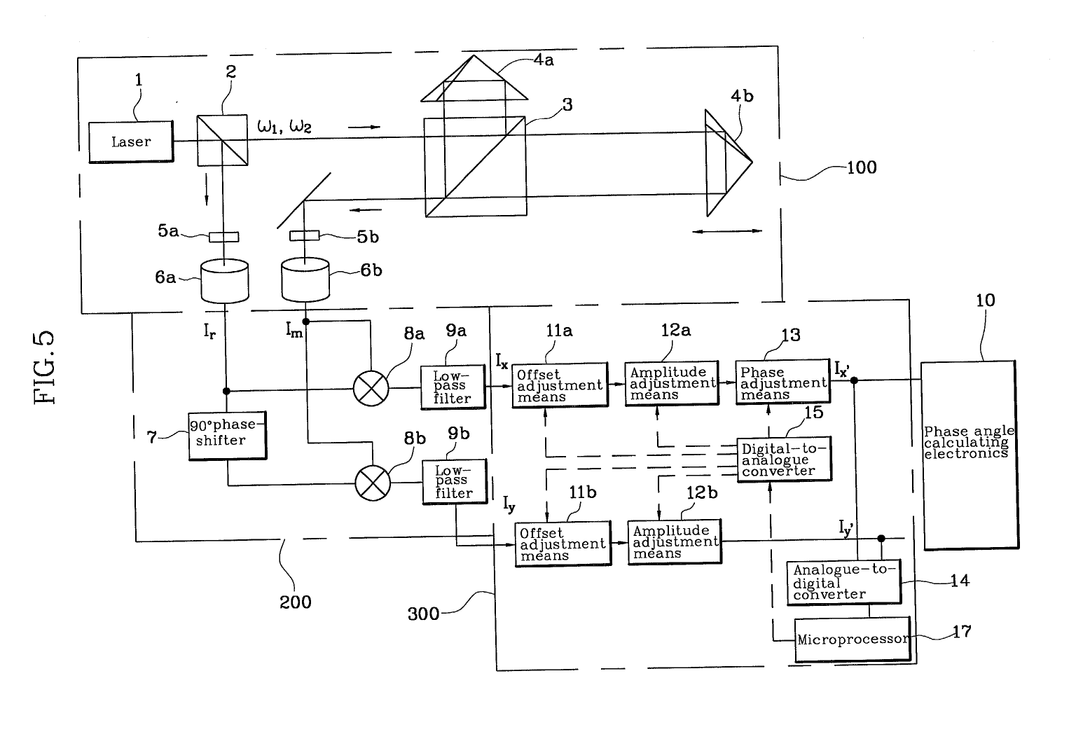

Referring to FIG. 4 and FIG. 5, the present invention includes a two-frequency laser interferometer 100 which outputs a reference signal Iᵣ produced due to an interference of two frequency laser beams and a measurement signal Iₘ produced due to an interference of two frequency laser beams reflected on fixed and moving mirrors 4a and 4b; a 90° phase mixing electronics 200 which mixes the reference signal Iᵣ and a 90° phase shifted reference signal with the measurement signal Iₘ from the interferometer 100, filters high frequency terms and outputs two output signals Iₓ and I_{y} for phase measurement; a nonlinearity error correcting electronics 300 which receives again output signals Iₓ′ and I_{y}′ from the nonlinearity error correcting electronics 300, obtains ellipse parameters including amplitudes a and b, offsets Iₓₒ and I_{yo} and difference from phase-quadrature φ of the output signals Iₓ′ and I_{y}′, calculates an adjusting voltage for correcting the amplitudes, the offsets and the phases of the output signals Iₓ′ and I_{y}, and conducts a correction wherein the offsets Iₓₒ and I_{yo} of the output signals Iₓ′ and I_{y}′ become zero, the amplitudes have a same value and difference from phase-quadrature φ of two output signals Iₓ′ and I_{y}′ becomes zero; and a phase angle calculating electronics 400 which obtains a phase angle θ by applying the output signals Iₓ′ and I_{y}′ from the nonlinearity error correcting electronics 300 to the following Equation θ=arctan(I_{y}′/Iₓ′).

In further detail explanation, the interferometer 100 includes a laser 1 which emits orthogonally linear-polarized laser beams with different frequencies ω₁ and ω₂; a beamsplitter 2 which divides the laser beams into a measurement beam incident to a polarizing beamsplitter and a reference beam incident to a photodetector 6a through a polarizer 5a; the photodetector 6a which detects a reference signal Iᵣ which is an interference signal of two laser beams from the reference beam of the beamsplitter 2 and provides the same to a mixer 8a and a 90° phase shifter 7; a polarizing beamsplitter which splits the laser beam transmitted from the beamsplitter into two beams incident to a fixed mirror and a moving mirror, mixes two laser beams reflected from two mirrors; and the photodetector 6b which detects a measurement signal Iₘ which is an interference signal of the two laser beams from the polarizing beamsplitter 3 and provides the same to mixers 8a and 8b.

The 90° phase mixing electronics 200 includes a 90° phase shifter 7 which 90 phase-shifts the reference signal Iᵣ provided from the photodetector 6a and provides the same to the mixer 8b; a mixer 8a which mixes the reference signal Iᵣ from the photodetector 6a with the measurement signal Iₘ from the photodetector 6b; the mixer 8b which mixes 90′ phase-shifted reference signal through the 90° phase shifter 7 with the measurement signal Iₘ from the photodetector 6b; and low pass filters 9a and 9b which eliminate high frequency terms from the output signals Iₓ′ and I_{y}′ from the mixers 8a and 8b and provide the same to offset adjustment means 11a and 11b.

The nonlinearity error correcting electronics 300 includes a microprocessor which obtains ellipse parameters including amplitudes a and b, offsets Iₓₒ and I_{yo} and difference from phase-quadrature φ of output signals Iₓ′ and I_{y}′ fed back from the nonlinearity error correcting electronics 300 through an analogue-to-digital converter 14 and calculates an adjusting voltage for correcting the amplitudes, the offsets and the phase of the output signals Iₓ′ and I_{y}′; offset adjustment means 11a and 11b which conduct a correction such that offsets Iₓₒ and I_{yo} of the output signals Iₓ′ and I_{y}′ fed back from the nonlinearity error correcting electronics 300 by the adjusting voltage output from the microprocessor 17 through a digital-to-analogue converter 15 become zero; amplitude adjustment means 12a and 12b which conduct a correction such that amplitudes a and b of the output signals Iₓ′ and I_{y}′ fed back through the nonlinearity error correcting electronics 300 by the adjusting voltage output from the microprocessor 17 through the digital-to-analogue converter 15 have the same value; and phase adjustment means 13 which conduct a correction such that difference from phase-quadrature φ between the output signals Iₓ′ and I_{y}′ fed back through the nonlinearity error correcting electronics 300 by the adjusting voltage output from the microprocessor 15 through the digital-to-analogue converter 15 becomes zero.

In particular, even if the offset adjustment means 11a and 11b, the amplitude adjustment means 12a and 12b and the phase adjustment means 13 of the nonlinearity error correcting electronics 300 are arranged in other order, the same effect can be obtained.

The nonlinear-free phase angle θ may be obtained in a manner that the phase angle calculating electronics 400 directly obtains the ellipse parameters including amplitudes a and b, offsets Iₓₒ and I_{yo} and difference from phase-quadrature φ of the output signals Iₓ and I_{y} from the 90° phase mixing electronics 200 and applies the ellipse parameters to the various Equations which will be explained hereinafter, without employing an automatic error correcting method using the nonlinearity error correcting electronics 300. However, this method has a limit in correcting the nonlinearity error in real time since lots of time are required for calculating Equation 22.

Further, the phase angle corresponding to the output signals Iₓ and I_{y} may be obtained from a lookup table which is made out in a manner that the ellipse parameters including amplitudes a and b, offsets Iₓₒ and I_{yo} and difference from phase-quadrature φ of output signals Iₓ and I_{y} from the 90° phase mixing electronics 200 are calculated, phase angles θ corresponding many sets of data of plural output signals Iₓ and I_{y} are calculated from Equation 22 and the calculated phase angles θ with regard to the output signals Iₓ and I_{y} are used to make the lookup table before displacement measurement.

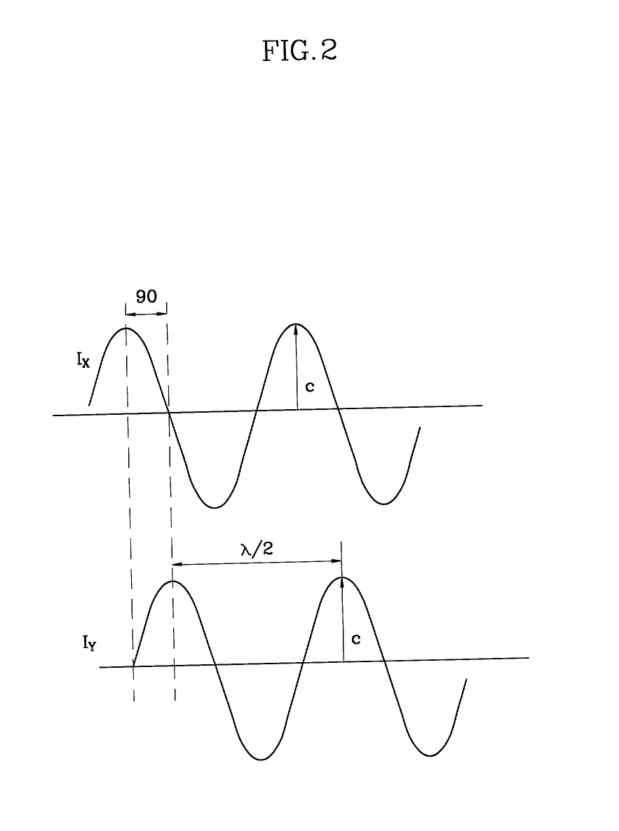

Before explaining the present invention, a nonlinearity error of a two-frequency laser interferometer will be theoretically described. As aforesaid, it is desirable that the two-frequency laser interferometer 100 does not have any nonlinearity error. In this case, two signals Iₓ and I_{y} from the 90° phase mixing electronics have pure sine and cosine of the phase as shown in FIG. 2. The amplitudes are same each other, phase offsets are zero, and phase difference between two signals is exactly 90°.

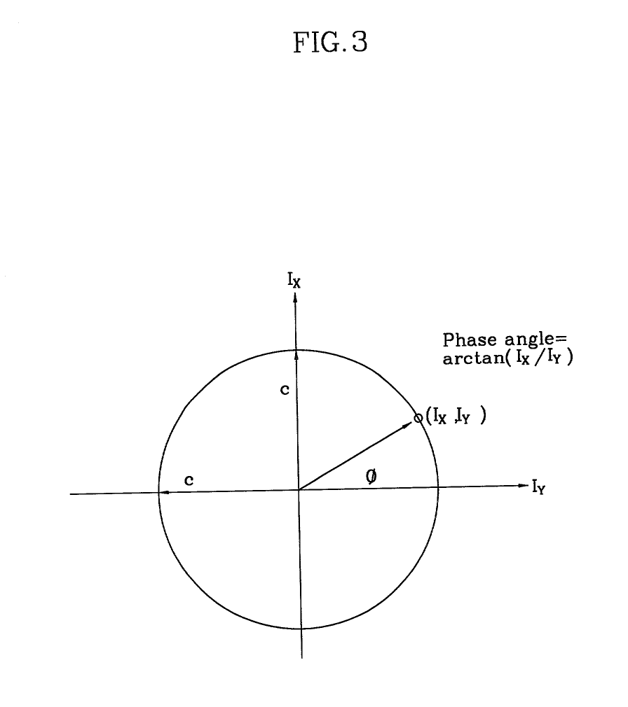

Here, according to the above output signals Iₓ and I_{y}, whenever the moving mirror 4b is displaced by as far as half wavelength λ/2, each period is changed. Therefore, a Lissajou figure of the output signals Iₓ and I_{y} becomes a perfect circle as shown in FIG. 3. In consequence, the phase angle θ can be easily obtained from Equation 12 which is same as an arctangent of Equations 10 and 11.

However, in real application, that beam reflected at the beamsplitter in FIG. 4 is not completely separated at the polarizing beamsplitter 3 so that each beam in the arms of the interferometer has small amount of other frequency and polarization direction, provided that frequency mixing is present.

On the assumption that amplitudes A and B are contaminated by the small amplitudes α and β which have the wrong phases respectively, these two beams with small amount of other frequency are reflected by the fixed mirror 4a and the moving mirror 4b respectively and recombined on the polarizing beamsplitter 3 again. Here, α and β are much smaller than A and B.

The two laser beams recombined by the polarizing beamsplitter 3 cover paths of the different length L₁ and L₂ and are detected as an interference signal of the two laser beams by the photodetector 6b through the polarizer 5b. The measurement signal Iₘ is expressed as shown in the following Equation 13:

[Equation 13]

Iₘ∝(A²+B²+α²+β²)/2+AB cos[Δωt+θ+(θ_{B}−θ_{A})]+Aβ cos[Δωt+(θ_{A}−θ_{β})]+Bα cos[Δωt+(θ_{B}−θ_{α})]+Aα cos[θ+(θ_{α}−θ_{A})]+Bβ cos[θ+(θ_{B}−θ_{β})]+αβ cos[Δωt−θ+(θ_{β}−θ_{α})]

It is out of question that the reference signal Iᵣ detected by the photodetector 6a is same as Equation 3. DC and quasi-DC terms in Iᵣ and Iₘ of Equations 3 and 13 are eliminated by a high-pass filter(not shown).

Thus, the reference signal Iᵣ of Equation 3 and the measurement signal Iₘ of Equation 13 can be expressed in a simpler form as the following Equations 14 and 15:

[Equation 14]

Iᵣ∝cos(Δωt)

[Equation 15]

Iₘ∝cos(Δωt+θ)+[(Aβ+Bα)/(AB)]cos(Δωt)+(αβ)/(AB)cos(Δωt−θ)=cos(Δωt+θ)+┌₁cos(Δωt)+┌₂cos(Δωt−θ)

where ┌₁ is (Aβ+Bα)/(AB) and ┌₂is αβ/AB.

A first term of Equation 15 is a base beat signal, and second and third terms of Equation 15 are terms causing a nonlinearity error.

The 90° phase mixing electronics 200 receiving two beat signals Iᵣ and Iₘ from the above photodetectors 6a and 6b outputs signals almost proportional to the sine and cosine of the phase angle θ.

In other words, the reference signal Iᵣ is divided into a reference signal Iᵣ and a signal having a 90° phase difference from the reference signal Iᵣ by the 90° phase shifter 7. The outputs Iₓ and I_{y} of the two mixers 8a and 8b, at which the measurement signal Iₘ provided from the photodetector 6b is multiplied by two phase-quadrature signals of the reference signal, are given by:

[Equation 16]

Iₓ=cos(Δωt)[cos(Δωt+θ)+┌₁cos(Δωt)+┌₂cos(Δωt−θ)]

[Equation 17]

I_{y}=sin(Δωt)[cos(Δωt+θ)+┌₁cos(Δωt)+┌₂cos(Δωt−θ)]

In the two multiplied signals Iₓ and I_{y}, the high frequency terms are eliminated by the low-pass filters 9a and 9b, so as to obtain signals Iₓ and I_{y} as shown in the following Equations 18 and 19 including the phase angle θ:

[Equation 18]

Iₓ=[(1+┌₂)/2]cos θ+┌₁/2

[Equation 19]

I_{y}=−[(1−┌₂)/2]sin θ

Referring to Equations 18 and 19, a radius of the ellipse in the Lissajou figure is distorted ┌₂ and the ellipse is shifted along the axis.

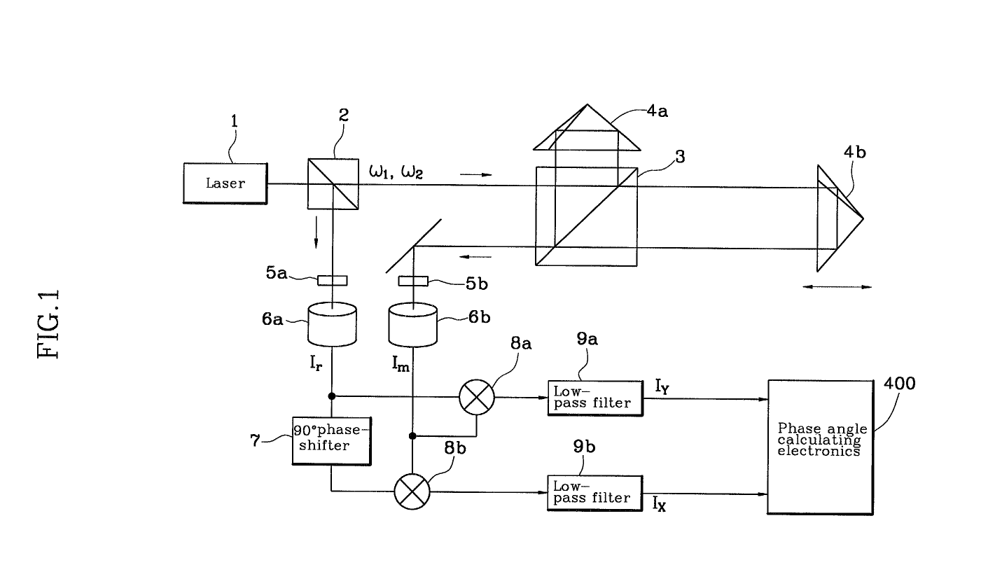

According to the conventional method of FIG. 1, the phase angle θ is directly obtained by Equation 12. However, Equation 12 does not provide an exact phase value when the laser interferometer has the nonlinearity terms like Equations 18 and 19. Therefore, Equation 12 cannot be used to calculate an exact phase when the nonlinearity error is present and should be modified.

As mentioned above, the fact that when a frequency mixing is present, the sine and cosine signals Iₓ and I_{y} which are outputs from the mixers 8a and 8b are distorted by the nonlinearity error and the phase angle calculation by Equation 12 can not provide an exact phase is a main idea of the present invention.

In real system, due to unequal gains, offsets of electronic circuit and lack of quadrature of 90° phase shifter 7 in displacement measuring electronics, the output signals from in the mixers 8a and 8b can be represented as the following Equations 20 and 21:

[Equation 20]

Iₓ=a cos(θ+φ)+Iₓₒ

[Equation 21]

I_{y}=b sin(θ)+I_{yo}

where a and b are amplitudes and Iₓₒ and I_{yo} are offsets and φ is a difference from the phase-quadrature.

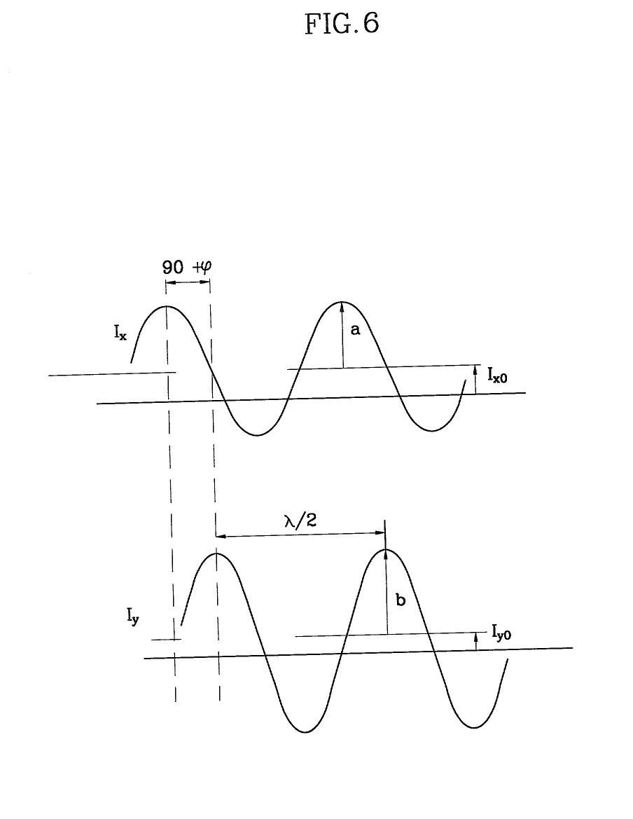

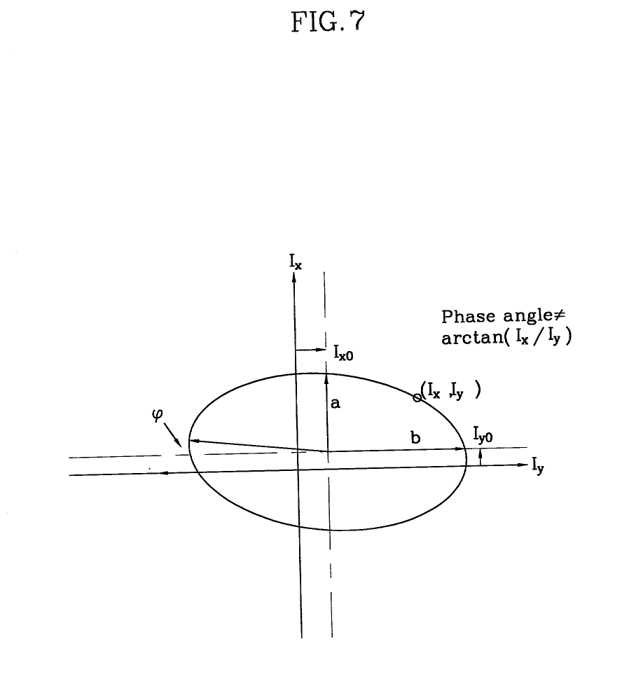

This means that the output signals Iₓ and I_{y} output from the mixers 8a and 8b are not signals having exact sine and cosine. As illustrated in FIG. 6, amplitudes are different, offsets are not zero, and a difference from the phase-quadrature is not zero. In a more clear explanation, the Lissajou figure of FIG. 7 is distorted and has an ellipse circle.

However, if we clearly know the ellipse parameters such as amplitudes a and b, offsets Iₓₒ and I_{yo} and a difference from the phase-quadrature φ in the above Equations 20 and 21, a corrected phase angle e can be determined by inducing the following Equation 22 from Equations 20 and 21:

[Equations 22]

θ=tan⁻¹[cos φ/[sin φ+(b/a)/(Iₓ−Iₓ₀)/(I_{y}−I_{y0})]]

The phase angle calculated by Equation 22 doesn't contain the nonlinearity error caused from the frequency mixing. Thus, the exact displacement L of the moving mirror 4b can be obtained from the phase angle θ calculated by Equation 22.

When the two-frequency laser interferometer 100 is nonlinear-free(amplitudes a and b are same, offsets Iₓₒ and I_{yo} and difference from the phase-quadrature φ are zero), Equation 22 is same as Equation 12, thereby having the same phase value as when there is no frequency mixing.

In real application, the phase angle may be measured by using the phase angle measuring system for displacement measurement of FIG. 4. To be specific, without a separate nonlinearity error correcting process, the output signals Iₓ and I_{y} output from the mixers 8a and 8b are converted through the analogue-to-digital converter 14 on a rear end of the mixers 8a and 8b and inputted into the phase angle calculating electronics 400. Then, the phase angle calculating electronics 400 applies the output signals Iₓ and I_{y} and the calculated ellipse parameters to Equation 22 to calculate the phase angle θ with respect to the pertinent output signals Iₓ and I_{y} every time and thus correct the nonlinearity error in the interferometer 100. However, calculating Equation 22 is a time consuming procedure, so the correction of the nonlinearity error by calculating ellipse parameters and Equation 22 can't be used for real time measurement.

Therefore, for faster correction, as illustrated in FIG. 4, the phase angles θ of many sets of data with respect to the output signals Iₓ and I_{y} from the mixers 8a and d8b are pre-calculated based on Equation 22 and stored at the lookup table 16 connected to the phase angle calculating electronics 400 without nonlinearity error correction. Whenever the signals Iₓ and I_{y} from the mixers 8a and 8b are inputted, corresponding phase angles θ are searched in the lookup table 16 to be corrected.

In other words, the phase angle calculating electronics 400 including the microprocessor reads the signals Iₓ and I_{y} inputted through the analogue-to-digital converter 14, and takes the phase angle θ of the set of data corresponding to the pertinent signals Iₓ and I_{y} from the lookup table 16 connected to the phase angle calculating electronics 400 including the microprocessor, so that the phase angle θ can be obtained in short time without a separate calculation by Equation 22.

Though this lookup table method is faster than the method directly calculating the phase using Equation 22, it can't be applied to the system where ellipse parameter values such as amplitude a and b and offsets Iₓₒ and I_{yo} are changed during the measurement.

If the output signals Iₓ and I_{y} from the mixers 8a and 8b in Equations 20 and 21 are electrically adjusted and corrected as Equations 10 and 11, in other words, if amplitudes a and b are adjusted to be same, and offsets and difference from phase-quadrature are adjusted to become zero, then the phase angle is exactly obtainable in almost real time without depending on the calculation by Equation 22.

The phase obtaining method using Equation 12 will not be explained in detail since it is sufficiently executable by those skilled in the field.

Referring to FIG. 5, the two output signals Iₓ and I_{y} from the 90° phase mixing electronics 200, namely, output signals Iₓ and I_{y} output from the low-pass filters 9a and 9b are inputted to the offset adjustment means 11a and 11b of the nonlinearity error correcting electronics 300.

The inputted signal I_{y} to the offset adjustment means 11a is converted by the analogue-to-digital converter 14 into the output signal I_{y}′ which is finally corrected through the amplitude adjustment means 12a and the phase adjustment means 13 and inputted to the microprocessor 17. The output signal Iₓ inputted to the offset adjustment means 11b is converted by the analogue-to-digital converter 14 into the output signal Iₓ′ through only the amplitude adjustment means 12b and inputted to the microprocessor 17.

That is to say, the output of the amplitude adjustment means 12b and the output of the phase adjustment means 13 are respectively converted into the digital signals by the analogue-to-digital converter 14 and inputted to the microprocessor 17. Thereafter, the microprocessor 17 calculates the ellipse parameters including amplitudes a and b, offsets Iₓₒ and I_{yo} and difference from the phase-quadrature φ based on the output signals Iₓ′ and I_{y}′ from the amplitude adjustment means 12b and the phase adjustment means 13 and determines feedback voltages for correcting the nonlinearity error including the offsets, the amplitudes, and the phase, namely the adjusting voltages for correction.

Next, the microprocessor 17 feeds back the five feedback voltages, namely the adjusting voltages to the nonlinearity error correcting electronics 300 through the digital-to-analogue converter 15 and corrects offsets, amplitudes and phases of the output signals Iₓ and I_{y} from the 90° phase mixing electronics 200, namely, the mixers 9a and 9b.

That is, the adjusting voltage outputs from the microprocessor 17 are inputted to the offset adjustment means 11a and 11b through the digital-to-analogue converter 15, such that the offsets Iₓₒ and I_{yo} of the output signals Iₓ and I_{y} output from the mixers 9a and 9b are corrected to become zero. Further, the adjusting voltage outputs from the microprocessor 17 are inputted to the amplitude adjustment means 12a and 12b through the digital-to-analogue converter 15, such that the amplitudes a and b of the signals output through the offset adjustment means 11a and 11b are corrected to have the same value. Finally, the phase adjustment means 13 receives the adjusting voltage output from the microprocessor 17, such that the phase difference between the two final output signals Iₓ′ and I_{y}′ through the offset adjustment means 11a and the 11b and the amplitude adjustment means 12a and 12b is corrected to become 90°, that is, the difference from the phase-quadrature φ is corrected to become 0°.

Accordingly, since the nonlinearity error, such as, unequal amplitudes a and b, non-zero offsets Iₓₒ and I_{yo} and nonzero difference from the phase-quadrature φ of the output signals Iₓ and I_{y} generated in the interferometer 100 and 90° phase mixing electronics 200 is corrected by the nonlinearity error correcting electronics 300, the signals Iₓ′ and I_{y}′ finally inputted to the microprocessor 17 become pure sine and cosine signals as shown in Equations 10 and 11.

The phase angle calculating electronics 400 receiving the two output signals Iₓ′ and I_{y}′ calculates the correct phase by means of a calculating circuit doing an arctangent function, and calculates magnitude of displacement of the moving mirror 4b based on the correct phase calculation result.

According to other preferred embodiment of the present invention, the offset adjustment means 11a and 11b, the amplitude adjustment means 12 and 12b and the phase adjustment means 13 in the nonlinearity error correcting electronics may have the free order.

For test purpose of the present invention, the performance of the system has been investigated by inputting two sets of output voltages, in other words, output signals Iₓ and I_{y} output from the low-pass filters 9a and 9b and output signals Iₓ′ and I_{y}′ output from the nonlinearity error correcting electronics 300 to a computer in which a predetermined algorithm for the performance test is embedded through the analogue-to-digital converter of a data acquisition board (not shown), and monitoring the results where the nonlinearity error is eliminated by correcting offsets, amplitudes and phases by means of the nonlinearity error correcting electronics 300.

That is, by measuring residual error of the respective two sets of output signals Iₓ and I_{y}, Iₓ′ and I_{y}′ it can be confirmed that the nonlinearity error is corrected. Here, the output signals Iₓ and I_{y} are signals before the nonlinearity error correction, which are obtainable by the conventional art, and the output signals Iₓ′ and I_{y}′ are signals after the nonlinearity error correction by means of the nonlinearity error correcting electronics 300 of the present invention and do not contain the nonlinearity error.

We have set the two-frequency laser interferometer 100 of FIG. 5 and installed the moving mirror 4b on a micro-moving stage which is driven by a piezo-transducer as far as scores of μm.

While the moving mirror 4b was slowly translated, the computer collected the output signals Iₓ and I_{y} from the low-pass filters 9a and 9b and the output signals Iₓ′ and I_{y}′ from the nonlinearity error correcting electronics 300, applied the same to the ellipse of Equations 20 and 21 and obtained the ellipse parameters with regard to the respective output signals Iₓ and I_{y}, Iₓ′ and I_{y}′. The obtained ellipse parameters were applied to Equations 12 and 22, respectively, to obtain respective phases, and then residual errors with regard to the two kinds of signals Iₓ and I_{y}, Iₓ′ and I_{y}′ were calculated from the phase value difference obtained by Equations 12 and 22.

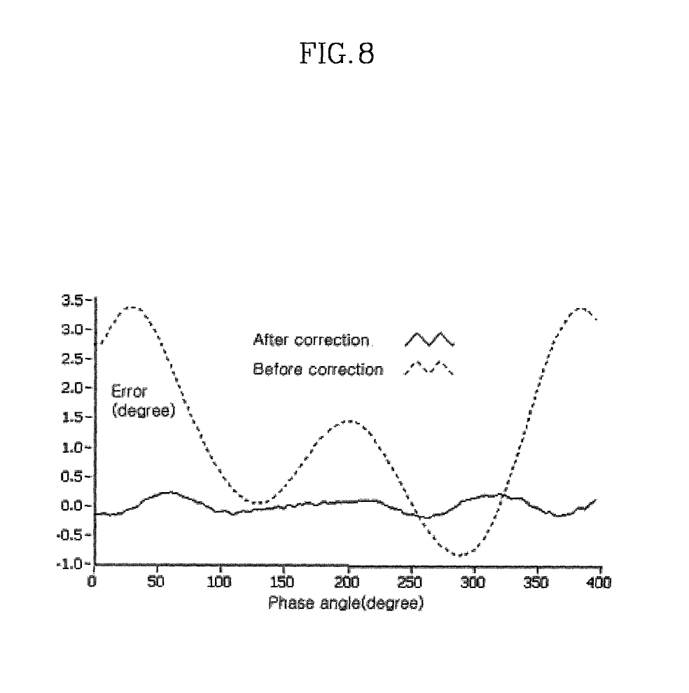

The residual errors calculated in this manner by the computer indicates the nonlinearity error that the laser interferometer has and the residual nonlinearity error remained after the error are corrected by the nonlinearity error correcting method of the present invention. As drawn in FIG. 8, a dotted line is result of the output signals Iₓ and I_{y} from the 90° phase mixing electronics 200 and a solid line is result of the output signals Iₓ′ and I_{y}′ from the nonlinearity error correcting electronics 300.

From FIG. 8, it is found that the output signals Iₓ′ and I_{y}′ after the nonlinearity error correction using the nonlinearity error correcting electronics 300 have much smaller error compared to the signals Iₓ and I_{y} before the nonlinearity error correction.

In order to evaluate the performance of the present invention quantitatively, the two-frequency laser interferometer 100 has been compared with a capacitance-type displacement gauge.

First, similarly to the above process, the two-frequency interferometer 100 was set, the moving mirror 4b was moved by using the piezo-transducer, and two sets of output signals Iₓ and I_{y}, Iₓ′ and I_{y}′ obtained from the two-frequency laser interferometer 100 of FIG. 5 were inputted to the computer with the outputs measured by the capacitance-type displacement gauge

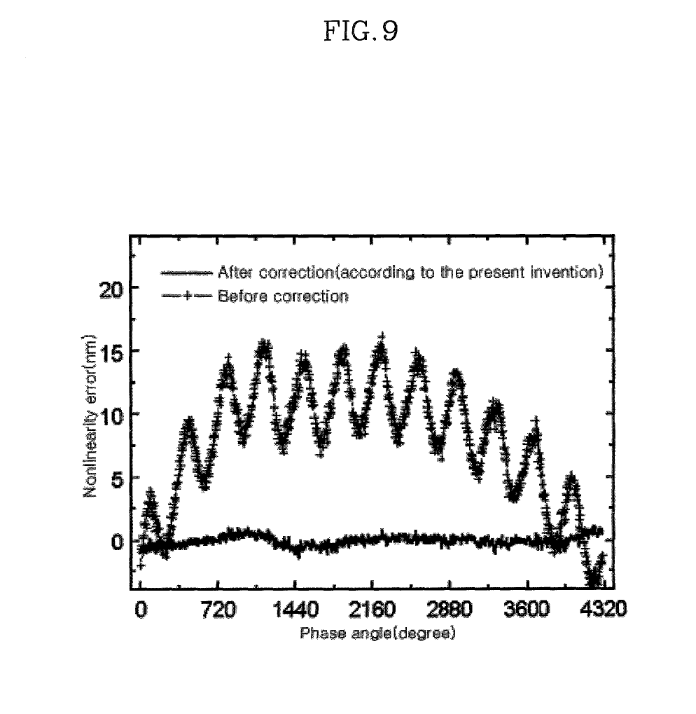

The difference between the uncorrected displacement of the moving mirror 4b calculated with the arctangent of the output signals Iₓ and I_{y} in Equation 12 and a linear fit of reading voltage of the capacitance-type displacement gauge is plotted with line with cross in FIG. 9. The periodic sinusoidal modulation which mainly comes from the nonlinearity of the two-frequency laser interferometer is shown in the figure, and slowly varying drift which mainly comes from the nonlinearity error of the capacitance-type displacement gauge is also shown.

The difference between the corrected displacement of the moving mirror 4b calculated with the arctangent of the output signals Iₓ′ and I_{y}′ of the nonlinearity error correcting electronics in Equation 12, and a 5^{th} order polynomial fit of reading voltage of the capacitance-type displacement gauge is plotted with solid line in FIG. 9.

At this point, the sinusoidal modulation shown in the figure plotted with line with cross is eliminated. It indicates that the nonlinearity error of the two-frequency laser interferometer 100 was removed.

Referring to FIG. 8 and FIG. 9, the nonlinearity error of the two-frequency laser interferometer 100 was eliminated by virtue of the application of the present invention. As a result, accuracy of the displacement measurement according to the present is superior to that of the conventional art in which the nonlinearity error is not eliminated.

Therefore, the present invention has an advantage of drastically improving accuracy in the displacement measurement using the two-frequency laser interferometer by correcting the offsets, the amplitudes and the phases of the output signals from the 90° phase mixer and thus eliminating the periodic nonlinearity error generated in the two-frequency laser interferometer.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A phase angle measuring method for displacement measurement in a two-frequency laser interferometer, which consists of a two-frequency laser interferometer, a 90° phase mixing electronics and a phase angle calculating electronics and performs the steps of mixing a reference signal produced due to an interference of two frequency laser beams and a 90° phase shifted reference signal with a measurement signal for displacement measurement produced due to two frequency laser beams reflected on fixed and moving mirrors, filtering high frequency terms to produce output signals and obtaining a phase angle for displacement measurement, the phase angle measuring method comprising the steps of:
obtaining output signals output from the 90° phase mixing electronics, and ellipse parameters such as amplitudes, offsets and a phase difference included in the output signals; and
applying the same to the following Equation to calculate the phase angle,
θ=tan⁻¹[cos φ/[sin φ+(b/a)/(Iₓ−Iₓₒ)/(I_{y}−I_{yo})]]

2. A phase angle measuring method for displacement measurement in a two-frequency laser interferometer, which consists of a two-frequency laser interferometer, a 90° phase mixing electronics and a phase angle calculating electronics and performs the steps of mixing a reference signal filtering high frequency terms to produce output signals and obtaining a phase angle for displacement measurement, the phase angle measuring method comprising the steps of:
obtaining output signals output from the 90° phase mixing electronics, and ellipse parameters, such as amplitudes, offsets and a phase difference included in the output signals which are output from the 90° phase mixing electronics;
applying the ellipse parameters and the output signals to the following Equation to calculate the phase angle;
making out a lookup table with data which consists of the output signals and the phase angle corresponding with them; and
reading the phase angle corresponding with the output signals output from the lookup table when the displacement measurement is required in real application.
θ=tan⁻¹[cos φ/[sin φ+(b/a)/(Iₓ−Iₓₒ)/(I_{y}−I_{yo})]]

3. A nonlinearity error correcting method for displacement measurement in a two-frequency laser interferometer, which consists of a two-frequency laser interferometer, a 90° phase mixing electronics, a nonlinearity error correcting electronics and a phase calculating electronics and performs the steps of mixing a reference signal produced due to an interference of two-frequency laser beams and a 90° phase shifted reference signal with a measurement signal for displacement measurement produced due to an interference of two-frequency laser beams reflected on fixed and moving mirrors, filtering high frequency terms to produce output signals, and obtaining a phase angle for displacement measurement, the nonlinearity error correcting method comprising the steps of:
calculating ellipse parameters, such as amplitudes, offsets and a phase difference of output signals which are output from the 90° phase mixing electronics;
calculating adjusting voltages for correcting the output signals and offsets, amplitudes and a phase of the output signals; and
conducting a correction wherein offsets of the output signals output from the nonlinearity error correcting electronics by the adjusting voltages become zero, amplitudes are same, and a phase difference beyond 90° between the output signals becomes zero.

4. A phase angle measuring method for displacement measurement in a two-frequency laser interferometer, which consists of a two-frequency laser interferometer, a 90° phase mixing electronics, a nonlinearity error correcting electronics and a phase calculating electronics and performs the steps of mixing a reference signal produced due to an interference of two-frequency laser beams and a 90° phase shifted reference signal with a measurement signal for displacement measurement produced due to an interference of two-frequency laser beams reflected on fixed and moving mirrors, filtering high frequency terms to produce output signals, and obtaining a phase angle for displacement measurement, the phase angle measuring method comprising the steps of:
calculating ellipse parameters, such as amplitudes, offsets and a phase difference of the output signals which are output from the nonlinearity error correcting electronics;
calculating adjusting voltages for correcting the output signals and offsets, amplitudes and a phase of the output signals;
conducting a correction wherein offsets of the output signals output from the nonlinearity error correcting electronics due to the adjusting voltages become zero, amplitudes are same, and a difference beyond 90° between the output signals becomes zero; and
applying the output signals whose offsets, amplitudes and phase are corrected to the following Equation to calculate the phase angle,
θ=arctan(I_{y}/Iₓ).

5. A phase angle measuring system for displacement measurement in a two-frequency laser interferometer, the phase angle measuring system comprising:
a two-frequency laser interferometer which outputs a reference signal produced due to an interference of two frequency laser beams and a measurement signal for displacement measurement produced due to an interference of two frequency laser beams reflected on fixed and moving mirrors;
a 90° phase mixing electronics which mixes the reference signal and a 90° phase shifted reference signal with the measurement signal output from the interferometer, filters high frequency terms and outputs output signals for phase angle measurement;
a nonlinearity error correcting electronics which receives again the output signals output from the nonlinearity error correcting electronics, obtains ellipse parameters such as amplitudes, offsets and a difference from phase-quadrature of the output signals, calculates adjusting voltages for correcting the amplitudes and the offsets of the output signals, and conducts a correction wherein offsets of the output signals become zero due to calculated adjusting voltages, amplitudes are same and a phase difference beyond 90° between the output signals becomes zero; and
a phase angle calculating electronics which obtains a phase angle by applying the output signals output from the nonlinearity error correcting electronics to the following Equation θ=arctan(I_{y}′/Iₓ′).

6. The phase angle measuring system of claim 5, wherein the interferometer includes:
a laser which emits two orthogonally linear-polarized beams which have different frequencies;
a beamsplitter which splits the laser into a measurement beam incident to a polarizing beamsplitter and a reference beam incident to a photodetector through a polarizer;
the photodetector which detects a reference signal as an interference signal of the two laser beams from the reference beam of the photodetector and provides the same to a first mixer and a 90° phase shifter;
the polarizing beamsplitter which splits the laser beam transmitted from the beamsplitter into two beams incident to a fixed mirror and a moving mirror, mixes two laser beams reflected from two mirrors; and
the photodetector which detects a measurement signal as an interference signal of the two laser beams from the measurement beam of the polarizing beamsplitter and provides the same to the first mixer and a second mixer.

7. The phase angle measuring system of claim 5, wherein the 90° phase mixing electronics includes:
a 90° phase shifter which 90° phase shifts the reference signal provided from a photodetector and provides the same to a second mixer;
a first mixer which mixes the reference signal output from the photodetector with the measurement signal output from the photodetector;
the second mixer which mixes 90° phase shifted reference signal through the 90° phase shifter with the measurement signal output from the photodetector; and
low pass filters which filter high frequency terms from the output signals output from the mixers and provides the same to offset adjustment means.

8. The phase angle measuring system of claim 5, wherein the nonlinearity error correcting electronics includes:
a microprocessor which obtains ellipse parameters such as amplitudes, offsets and a phase difference of output signals fed back from the nonlinearity error correcting electronics through an analogue-to-digital converter and calculates adjusting voltages for correcting the amplitudes, the offsets and the phase of the output signals;
offset adjustment means which conducts a correction wherein offsets of output signals fed back from the nonlinearity error correcting electronics due to the adjusting voltages output from the microprocessor through a digital-to-analogue converter become zero;
amplitude adjustment means which conduct a correction wherein amplitudes of the output signals fed back through the nonlinearity error correcting electronics by the adjusting voltages output from the microprocessor through the digital-to-analogue converter are same; and
phase adjustment means which conducts a correction wherein a phase value in excess of 90° between the output signals fed back through the nonlinearity error correcting electronics by the adjusting voltages output from the microprocessor through the digital-to-analogue converter becomes zero.

9. The phase angle measuring system of claim 5 or claim 8, wherein the offset adjustment means, the amplitude adjustment means and the phase adjustment means of the nonlinearity error correcting electronics can be arranged in a free order.
